(19) United States
(12) Patent Application Publication
(10) Pub. No.: US 2016/0230042 A1
(43) Pub. Date: Aug. 11, 2016

(54) SILANE END CAPPED SUBSTITUTED UREA RESINS AND COATINGS THEREOF

(71) Applicant: The Government of the United States of America, as represented by the Secretary of the Navy, Arlington, CA (US)

(72) Inventors: Arthur A. Webb, Bethesda, MD (US); Jozef Verborgt, Dunedin, FL (US)

(73) Assignee: The Government of the United States of America, as represented by the Secretary of the Navy, Arlington, VA (US)

(21) Appl. No.: 15/134,808

(22) Filed: Apr. 21, 2016

Related U.S. Application Data
(63) Continuation-in-part of application No. 14/190,448, filed on Feb. 26, 2014.
(60) Provisional application No. 61/772,132, filed on Mar. 4, 2013.

(51) Int. Cl. C09D 183/02; C09D 5/18

(52) U.S. Cl. CPC C09D 183/02; C09D 5/18

(57) ABSTRACT

A method and coating made thereby of: reacting a 3-trialkoxysilylpropyl amine with an organic compound having a carbon-carbon double bond activated by an electron withdrawing group; followed by reacting with an aliphatic polyisocyanate; followed by optionally performing a silicate condensation with a hydrolyzed silicate; followed by application to a surface and moisture curing to form oxygen crosslinks between silicon atoms and loss of alkyl alcohols to form the coating. The compounds before moisture curing are shown below. R¹ is an alkyl group; R³ and R⁴ are organic groups; R⁵ is the residue of the polyisocyanate; R⁶ contains the electron withdrawing group; R⁷ is an alkyl group; R^{1′} is R¹ or —(SiR⁷₂—O)ₘ—R⁷; at least one of the R^{1′} groups is —(SiR⁷₂—O)ₘ—R⁷; m is a positive integer; and n is an integer greater than or equal to 2.

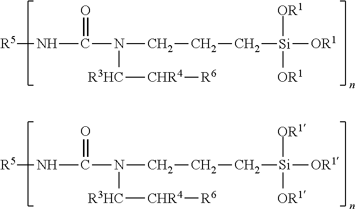

This application is a continuation in part application of U.S. patent application Ser. No. 14/190,448, filed on Feb. 26, 2014, which claims the benefit of U.S. Provisional Appl. No. 61/772,132, filed on Mar. 4, 2013. The provisional application and all other publications and patent documents referred to throughout this nonprovisional application are incorporated herein by reference.

### TECHNICAL FIELD

The present disclosure is generally related to one component cured coatings.

### DESCRIPTION OF RELATED ART

A large amount of solvent based silicone modified alkyds with a relatively high content of volatile solvents (VOCs) are presently used. All existing top coats show various amounts of VOCs depending on their chemistry and way of application. Even the use of VOC exempt solvents like OXSOL®, which is a fluorinated synthetic solvent, is not a good solution for the environment.

The U.S. Navy presently employs fire resistant coatings to all habitability and machinery spaces aboard all ships and submarines. These coatings consist of two different products designed to resist combustion during a fire situation and also formulated to be non-flaming, i.e., they will not support sustained combustion. However, it has been well documented that under any shipboard fire there are certain conditions and situations where these coatings will burn. Under these conditions, the coatings when ignited, release a wide series of toxic products to include dioxin, hydrochloric acid, and perchlorates. As in most shipboard fires, it is not the fire itself that results in fatalities, but rather it is the smoke and toxic fumes release from burning materials (i.e. coatings) that result in severe injuries and or fatalities. As shown in FIG. 1 the standard MIL-DTL-24607 chlorinated alkyd will burn albeit to a lesser degree than a normal coating but in this process, copious quantities of heavy smoke and halogens are released.

Although rare within the U.S. Navy, shipboard fires can have disastrous consequences. The fire on the USS Stark in May 1987 as a result of a missile strike, burned for nearly 24 hours wherein 29 men were killed in the explosion and resultant fire, the majority of the fatalities were primarily due to smoke inhalation and the toxic constituents from burning paint, insulation and other polymeric materials. Recently the shipboard fire on the USS Miami was supported primarily by interior coatings, insulation, and other polymeric materials after the initial combustion source was exhausted.

Shown below is a typical structure of a chlorinated alkyd resin. Chlorinated non-flaming paints have been an industry standard for shipboard interior coatings for more than 40 years and have, in most cases, provided adequate performance provided that they are fully dry and not applied at excessive thickness. However, based on several environmental and health and safety concerns, coatings containing halogenated resins are becoming increasingly more costly to produce. For example, chlorinated alkyd resins are synthesized by copolymerization of a normal vegetable oil triglyceride with pentaerthritol/glycerol and chlorendic anhydride. The resultant resin contains roughly 16 percent halogenated organic (chlorendic anhydride) and 84 percent vegetable oil fatty acid ester. The total chlorine content is approximately 8-12 percent depending on the ratio of oil/pentaerthritol/glycerol/chlorendic anhydride when resin is produced. Nevertheless the resin contains a substantial proportion of combustible fatty acid which will burn. Furthermore the low crosslink density of alkyd type coatings results in a significant proportion of the coating melting and dripping leading to release vaporized and readily flammable material.

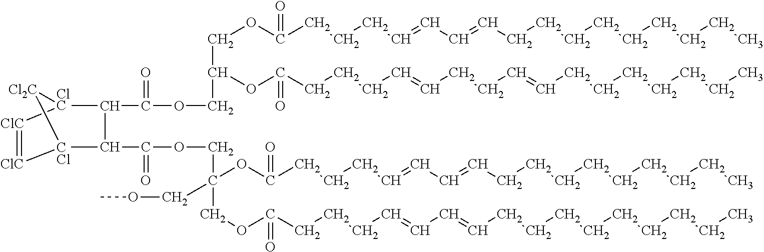

Although chlorinated alkyds are the predominant shipboard interior non-flaming coating there is another system that is employed when the use of chlorinated alkyds are not desired or possible. Shown below is a typical chlorinated vinyl resin as is employed as a waterborne latex-type system. Chlorinated vinyl resins are primarily employed where low odor and lower solvent content are required by regulation. However, the vinyl based resins have 60-65 percent chlorine by weight and therefore have higher release potential than the alkyd based system. Furthermore, being waterborne, the coatings are often problematic when they applied in poorly ventilated shipboard interior spaces where relative humidity levels are high. Given that the coating hardens by water (and solvent) evaporation and particle coalescence, this type of coating may remain wet and easily damaged for several days or more depending on ventilation refresh rate, temperature, and relative humidity. Furthermore the chlorinated vinyl systems are generally much softer and more easily damaged than a fully dried chlorinated alkyd system.

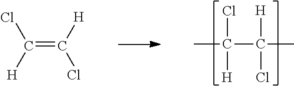

Noting the physical attributes desired for a shipboard interior coating most importantly, gloss, durability, ease of cleaning, general overall aesthetics, and non-flaming performance, the development of a system with same performance without using halogenated resins is challenging. Although there are high temperature silicone based coatings, they are a high solvent containing a blend of acrylic and silicone resin wherein the acrylic serves as the primary binder holding the silicone resin in place. When heated to 200-300° F., the acrylic resin is vaporized off and the silicone crosslinks to form a fairly robust, durable film with excellent non-flaming characteristics. However until heated for cure, the coating is essentially uncured, and is easily damaged. There are pure silicone systems as well, but again, they must be heated to force curing of the resin, an operation that is impractical for large structures. Unlike traditional organic coatings, silicone systems possess outstanding thermal resistance and in most cases will resist continuous operation in excess of 700° F. and specialized systems will maintain their appearance and durability after thermal excursions up to 1200° F. which is perhaps far hotter than any shipboard fire under all but the most extreme circumstances.

### BRIEF SUMMARY

Disclosed herein is a method and coating made thereby. The method comprises: reacting via a first reaction a 3-trialkoxysilylpropyl amine with an organic compound having a carbon-carbon double bond activated by an electron withdrawing group to form a secondary amino propylalkoxysilane; reacting via a second reaction the secondary amino propylalkoxysilane with an aliphatic polyisocyanate or a polymer thereof to form a reaction product; optionally performing a silicate condensation between the reaction product and a hydrolyzed silicate having the formula R⁷—[O—Si(OR⁷)₂]ₘ—OR⁷ to form a modified compound; applying the reaction product or the modified compound to a surface; and moisture curing the reaction product or the modified compound to form oxygen crosslinks between silicon atoms and loss of alkyl alcohols to form the coating. The coating is inert to reactions with epoxy groups and/or is at least 5 mil thick. The reaction product and the modified compound are shown below.

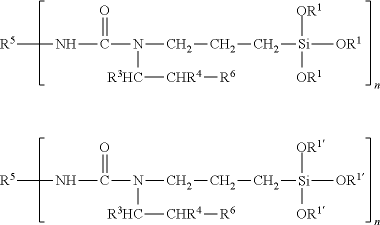

Each R¹ is an independently selected alkyl group.

Each R³ and R⁴ is an independently selected organic group.

R⁵ is the residue of the polyisocyanate.

R⁶ comprises the electron withdrawing group bound to a carbon atom, which is bound to the CHR⁴ group.

Each R⁷ is an independently selected alkyl group

Each R^{1′} is R¹ or —(SiR⁷₂—O)ₘ—R⁷.

At least one of the R^{1′} groups is —(SiR⁷₂—O)ₘ—R⁷.

The value m is a positive integer.

The value n is an integer greater than or equal to 2.

### BRIEF DESCRIPTION OF THE DRAWINGS

A more complete appreciation of the invention will be readily obtained by reference to the following Description of the Example Embodiments and the accompanying drawings.

FIG. 1 shows results of MIL-DTL-24607 chlorinated alkyd after 20 seconds at 900° F.

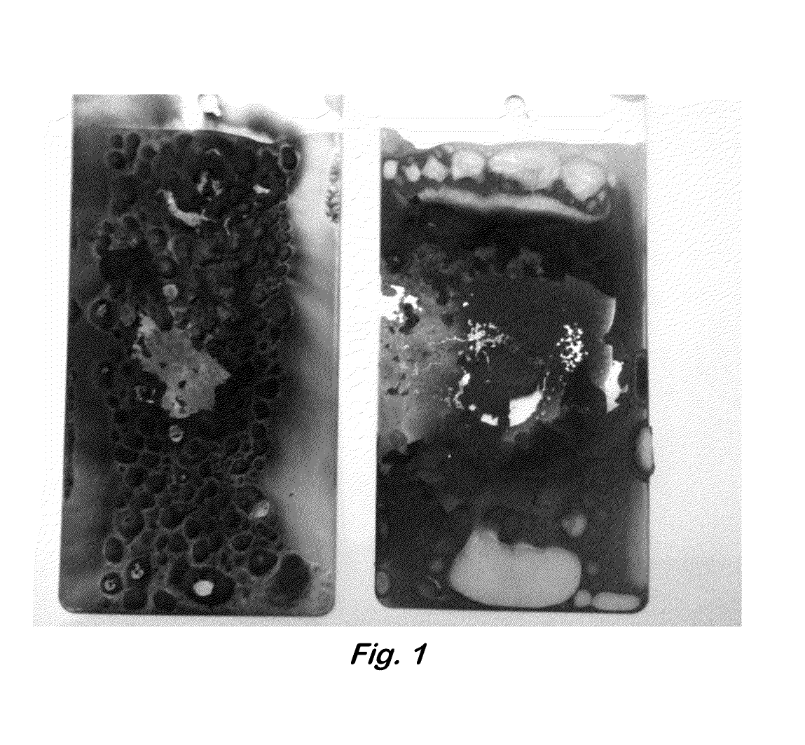

FIG. 2 shows fire resistance of the APTMS “Base Adduct” after 20 seconds at 900° F. flame. Note the melted aluminum panel.

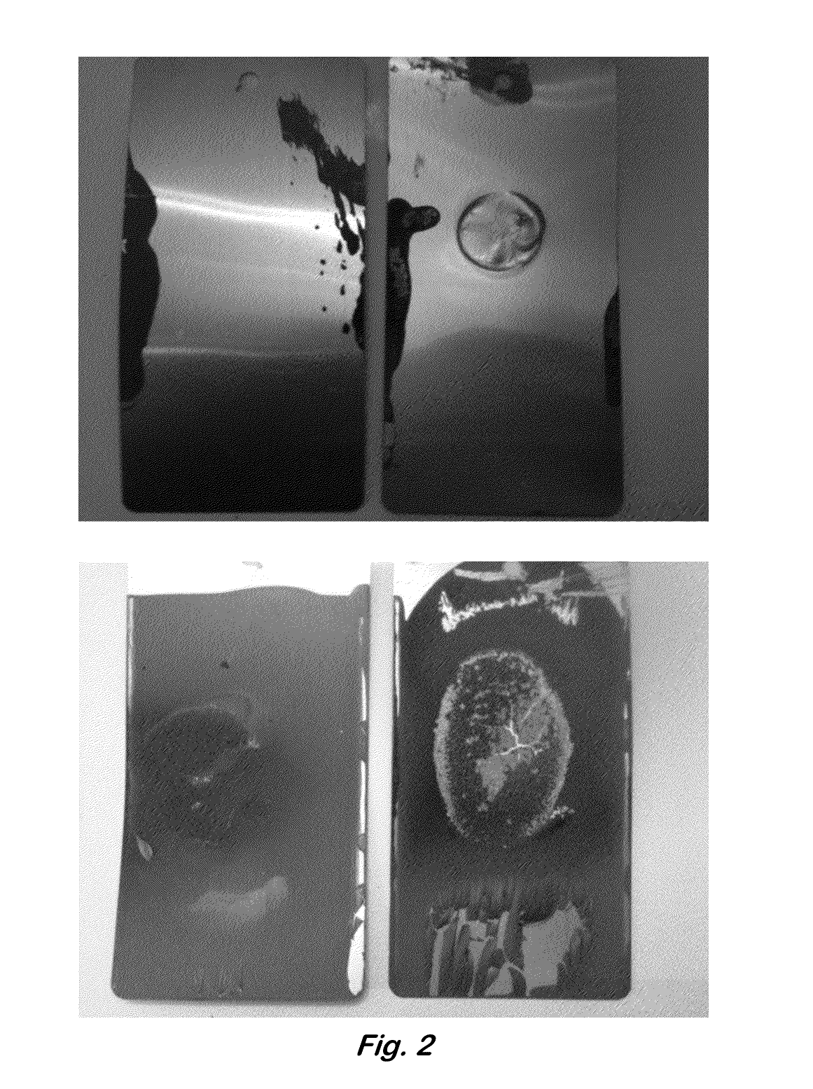

FIG. 3 shows high gloss white 1K coating formulated from the coupled adduct and polysilicate.

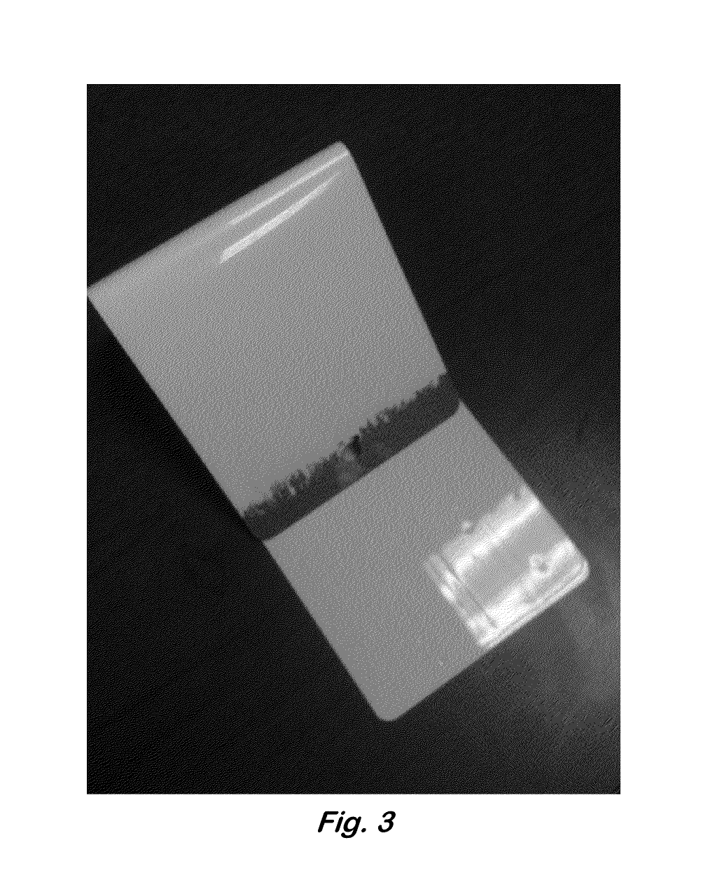

FIG. 4 shows results of fire resistance testing of the adduct coupled with functional organic group. Note system gloss retention and limited degree of discoloration spread during the test.

FIG. 5 shows results of fire resistance testing of the adduct coupled with functional silicone. Material disbonded and turned brown but could not be ignited.

FIG. 6 shows result of fire resistance testing of the siloxane-silicate hybrid system. Note how product only slightly discolors and falls off panel.

FIG. 7 shows a Comparison of the different variation of the siloxane-silicate hybrid system on steel panels. Note only that area directly in the flame is degraded and the absence of smoke.

FIG. 8 shows results of resistance to ignition and smoke and toxicity testing. Note the retention of color for the pigmented samples.

### DETAILED DESCRIPTION OF EXAMPLE EMBODIMENTS

In the following description, for purposes of explanation and not limitation, specific details are set forth in order to provide a thorough understanding of the present disclosure. However, it will be apparent to one skilled in the art that the present subject matter may be practiced in other embodiments that depart from these specific details. In other instances, detailed descriptions of well-known methods and devices are omitted so as to not obscure the present disclosure with unnecessary detail.

A series of single component polysiloxane based non-flaming coatings (1K FRC) have been developed and tested. Thus far the coatings perform as well as the U.S. Navy's current MIL-DTL-24607 chlorinated alkyd. However, unlike traditional non-flaming coatings which contain halogenated constituents or copolymers, the present system relies on the inherent fire resistance of polysiloxane resins and for performance and where, needed can incorporate non-halogenated additives and reactive diluents. The newly developed systems have the handling, application, and general overall appearance of a traditional high performance high gloss/semi-gloss coating but with the convenience of single component application and drying.

Disclosed are a series of alkoxyfunctional polysiloxane resins which can be co-reacted with organic resins to produce a single component (air dry) non-flaming interior coating which looks and handles just like the current chlorinated organic systems. Furthermore, these polysiloxane systems can be reacted with low cost functional silicone resins to produce a further enhanced system with all the application and handling properties of a traditional single component organic resin-based coating. The percentage of organic to inorganic component in these newly developed 1K polysiloxane coatings can be varied widely to balance cost and performance depending on the actual area of use. Furthermore, it has been demonstrated that these newly developed polysiloxane coatings have notable adhesion to aluminum and as such may be a possible replacement for 2K and 1K polyurethanes for aircraft.

The basis of the polysiloxane coatings begins with the base functional silane. In the first example, the binder system was developed from commercially available aminopropyl trimethoxysilane (APTMS). APTMS is commonly employed as an adhesion promoter for coatings specifically for steel, aluminum, and glass. Traditionally employed at 1-2% of the total volume of coating binder, APTMS has a dramatic effect on system adhesion. In its neat state APTMS will react with airborne moisture and condense to form a polysiloxane but it lack mechanical strength, is friable and easily damaged. In order to promote mechanical strength, APTMS is co-reacted with a functional organic material to provide enhanced toughness and durability. In this example APTMS is reacted with n-butyl acrylate. Michael addition of the acrylate to the amine of APTMS results in a “base adduct” consisting a butyl-acrylate terminated secondary amine of propyl trimethoxysilane. This base adduct in itself possesses very low viscosity and is suitable as a binder for coatings but is highly reactive toward atmospheric moisture and the alkylsilanes will readily condense with one another to form a very hard and brittle product. However the thermal resistance of the base adduct is remarkable. Although possessing a nearly 60% organic structure, coatings made from the base adduct alone are highly resistant to both direct and indirect flame impingement.

However the storage stability of the base adduct is short and when formulated into a coating, moisture present in pigments and additives causes significant reduction in shelf life. Samples made from the adduct and pigmented with inorganic pigments such as titanium dioxide (TiO₂) and iron oxides remain as liquids for only two to three days before gelling.

An improvement in system handling properties, storage stability as well as system appearance can be achieved by coupling the base adduct with a functional organic or a functional silicone resin. As a result the “coupled adduct” binder or resin has a more bodied consistency. In the case of the APTMS base adduct, the secondary hydrogens resulting from the Michael addition of the acrylate are reacted with aliphatic isocyanate to form a substituted urea. The resulting prepolymer is now an alkoxysilane-terminated acrylic polyurea possessing the gloss and leveling attributes of an acrylic, the toughness of a polyurea, and the fire resistance and adhesion performance of a polysiloxane. In short the product has the best attributes offered by each of the three initial raw materials.

Further enhancements of the system performance to include adhesion, flexibility, and fire resistance can be made by blending in varying degrees of polysilicate. In addition, the polysilicate significantly reduces the product viscosity and aides in system curing. The level of polysilicate is however critical in that too little offers no improvement and too much can result in incompatibility and ultimately gelling of the formulation after only a few hours. As such, in order to generate a relatively stable system requires special care in formulation, but once parameters are known, the process can be reproduced with certainty. The polysilicate blended 1K systems are extremely hard and scratch resistant, flexible, and very resistant to solvents. The coatings are unaffected by acetone and methylethylketone and samples immersed on aircraft hydraulic fluid show no signs of degradation and or change in appearance after nearly 5 months. These are ideal attributes for a coating being designed for shipboard interior spaces.

The present compositions allow for the formulation of odor free and solvent free one component moisture curing coatings that can easily be applied. The coatings can be brushed, rolled, or spray applied and cured into a hard, scratch resistant coating with an exceptional weatherability for a much extended service life. The coatings may strongly reduce the annual emission of VOCs and lower the cost of maintenance substantially. The coatings can also be formulated into self-extinguishing coatings for interiors of ships or can be formulated into CARC coatings with increased chemical resistance and cleanability.

Due to the intrinsic low viscosity of the resins the coatings can be formulated into aerosol coatings with substantially reduced amounts of solvents. The coatings may offer an interesting potential for use in commercial fleets as well as in the building and retail markets. Brush or roller applied coatings tend to have higher VOCs than coatings that are applied airless. The disclosed resins can provide VOC free application with airless spray equipment and 10% of less solvent for either brush or roller application.

Existing high quality urethanes, acrylates, and polysiloxanes are higher in VOC content. The weatherability of the disclosed resin is better than for urethanes and equals the weatherability of the best existing polysiloxanes. Note that all polysiloxanes do emit either methanol or ethanol during the curing stage.

The synthesis of the resins does not require any chemical reactors or capital investment and can be done in any existing paint factory. The two step reaction is done by mixing chemicals. The resin at the end of the two step process is entirely free of any active isocyanate and applicators or users will never be exposed to potentially harmful isocyanates.

Although there are secondary amino propyl alkoxy silanes commercially available, these tend to be expensive. The present compositions provide for a new abundant and more affordable source of secondary amino propyl silanes lowering the cost of the coating.

The first step of the reaction entails the production of a secondary amino propyl trialkoxy silane by way of a Michael addition reaction of an activated double bond to the primary amino group. The double bond is activated by an electron withdrawing group bound to a carbon atom adjacent to the double bond. Suitable reagents have the formula R³HC═CHR⁴—R⁶ and include, but are not limited to, a diester of maleic acid or fumaric acid, an acrylic or methacrylic ester, acrylonitrile, diethyl maleate, diethyl fumarate, butyl acrylate, and butyl methacrylate. The 3-trialkoxysilylpropyl amine has the formula NH₂—CH₂—CH₂—CH₂—Si(OR^{1′})₃. Suitable R^{1′} include but are not limited to methyl and ethyl.

Both reagents are mixed neat under a blanket of inert and dry gas. A mild exotherm occurs after the addition which requires either mild cooling of the mixture or adding the mixture over an extended period of time. The bulk of the reaction is usually over in a few hours and the reaction product can then be stored in drums or tanks. The reaction is fully completed after some two to three days and is than ready to be used for the second step. Note that there is no need for purification of the reaction product.

The reactions of butyl acrylate with 3-trimethoxysilylpropyl amine and diethyl maleate with 3-triethoxysilylpropyl amine are shown below.

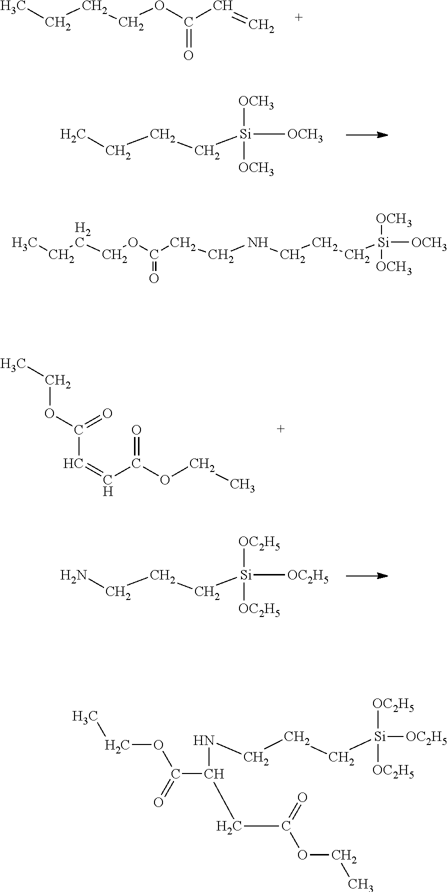

The second step is then carried out again preferably under a dry and inert blanket by adding stoichiometric amounts of an aliphatic isocyanate to the secondary amino propyl silane. A “stoichiometric amount” means that there are approximately an equal number of secondary amino groups and isocyanate groups in the reaction. A slight excess of the amine should ensure that there are very few to no unreacted isocyanate groups. Any aliphatic polyisocyanate may be used, including polymers thereof. Such polymers include, but are not limited to, biurets and cyclic dimers and trimers.

This reaction can be done neat but can also be done in solution but preferably at very high concentrations. A mild exotherm does occur and it is advantageous to spread the addition of the isocyanate over a couple of hours or alternatively to apply some mild cooling. Note that the exotherm is limited and the reaction cannot get out of control thermally. The reaction is virtually complete after one hour at ambient temperature and the resin is ready to make paint or to be stored in tanks. Depending on the intended application it is possible to add solvents, plasticizers, or reactive diluents before storing the resin in tanks.

The reactions of the above amines with bis(4-isocyanatocyclohexyl)methane and hexamethylene diisocyanate cyclic trimer/dimer (DESMODUR® N3400) (HDI isocyanurate) are shown below. Any aliphatic isocyanate may be used, such as isophorone diisocyanate, including aromatic isocyanates where the isocyanate groups are bound to aliphatic groups, such as 1,3-bis(2-isocyanatopropan-2-yl)benzene (tetramethylxylylene diisocyanate).

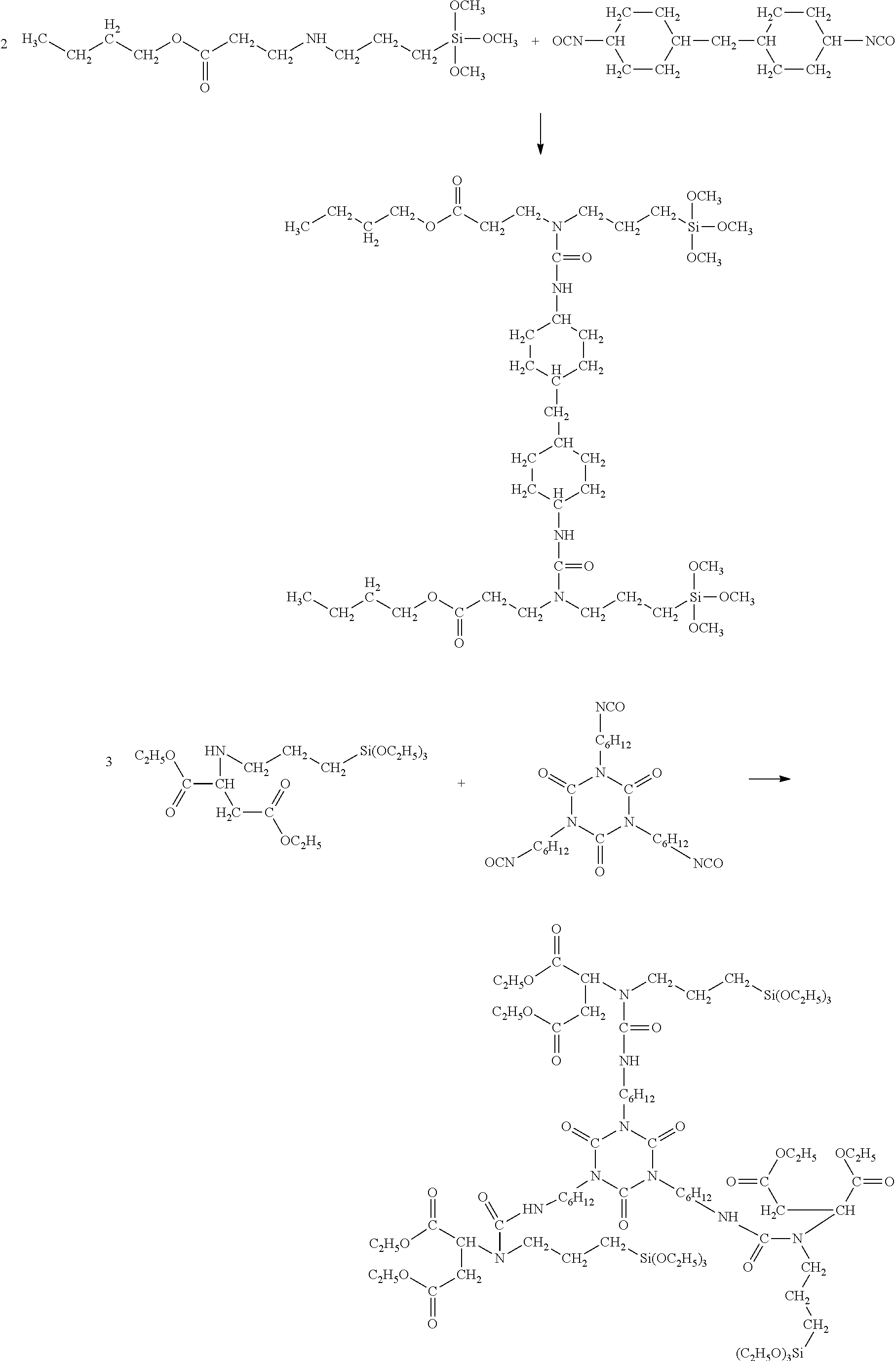

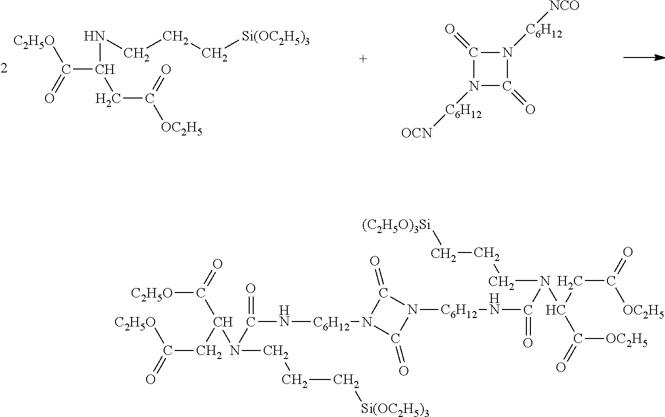

In an optional third step, a silicate condensation is performed between the compound and a hydrolyzed silicate having the formula R⁷—[O—Si(OR⁷)₂]ₘ—OR⁷, such as C₂H₅—[O—Si(OC₂H₅)₂]₃—OC₂H₅. At least one of the silyl alkoxy groups may be substituted by the hydrolyzed silica, and the hydrolyzed silica may join two of the compounds. The formula below shows an example.

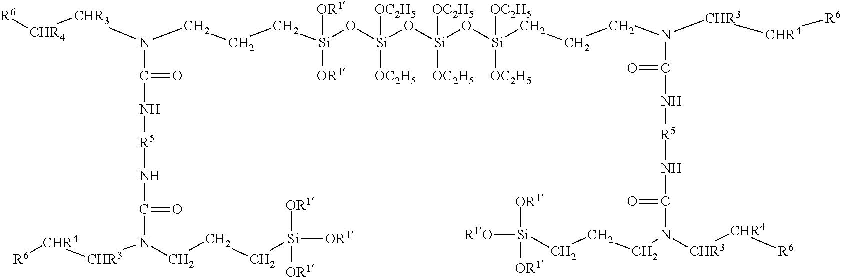

Coatings can then be produced by grinding the customary pigments, fillers, catalyst, and additives. Grinding can be done by either cowless or sand mil or any other modern way of grinding paint. The resin, with or without the hydrolyzed silicate, is applied to a surface. It may then moisture cure to form oxygen crosslinks between silicon atoms as shown below. This also produces a loss of alkyl (R^{1′}) alcohols. The coatings are inert to reactions with epoxy groups in that no measurable or significant amount of an epoxy compound can be covalently bound to the coating. For example, an attempt to bond an epoxy compound to the coating may result in less than 1% of the area of the coating having the epoxy compound bound thereto. The coating may be inert to reactions with other chemical functional groups as well. Further, at least 10%, 20%, or 50% of the alkoxy groups may be converted to oxygen crosslinks or OH groups.

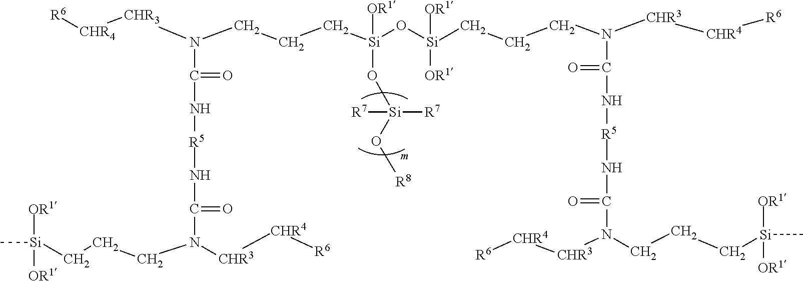

The compositions may exhibit: 1) a new and abundant source of secondary amino propyl alkoxy silanes, 2) resins with a very low molecular weight and intrinsic low viscosity allowing for solvent free, odor free and relatively fast drying coatings, and 3) very good weathering equal to the best available siloxanes on the market.

The main problem of polysiloxanes is cost. By modifying the amino silane a good amount of cheap but performing “content” is added to the resin resulting in a commercially more attractive product opening up new markets. The new technology is very suitable for formulating self-extinguishing coatings, CARCs and other high performance camouflage coatings. The coatings are much more robust and scratch resistant than any other existing coating. The use of these coatings to protect aluminum is suitable and these coatings are prime candidates to replace existing high VOC coatings which are used today.

The following examples are given to illustrate specific applications. These specific examples are not intended to limit the scope of the disclosure in this application.

### Example 1

### Methods

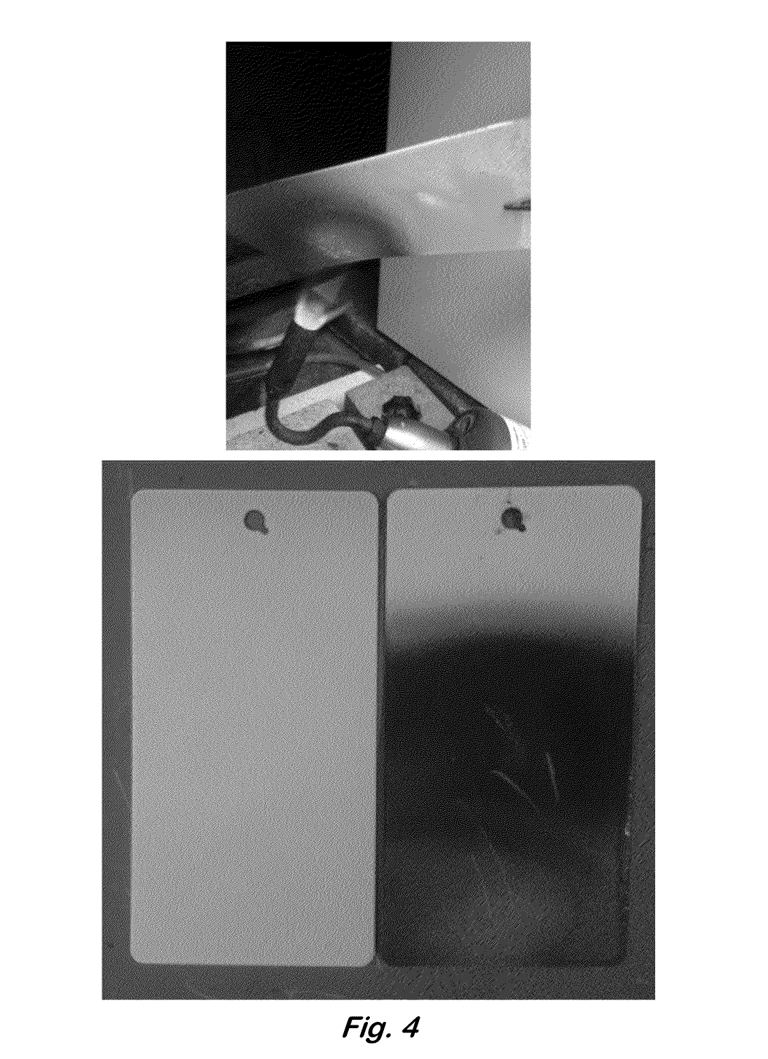

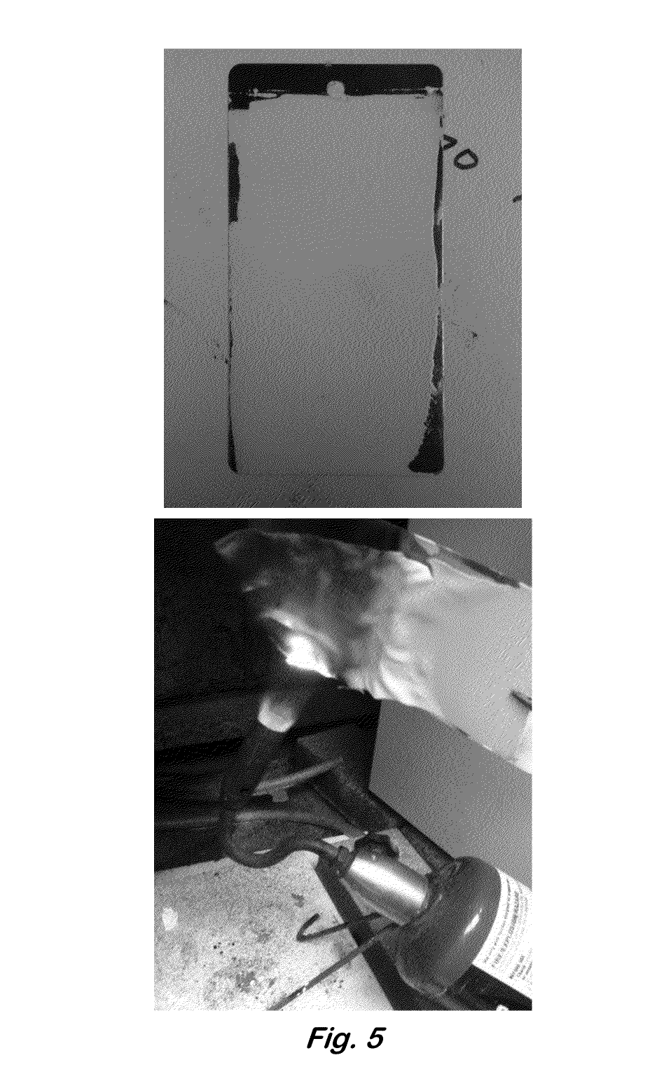

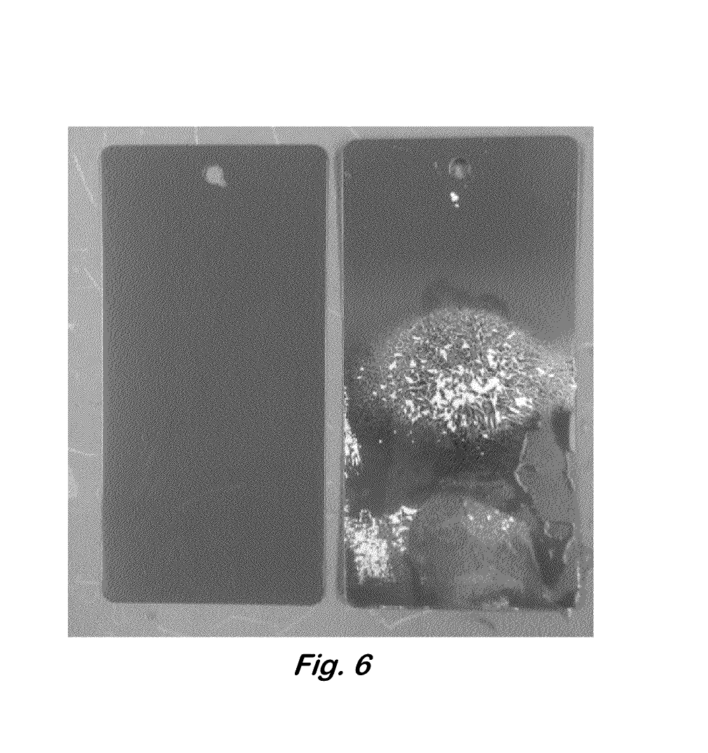

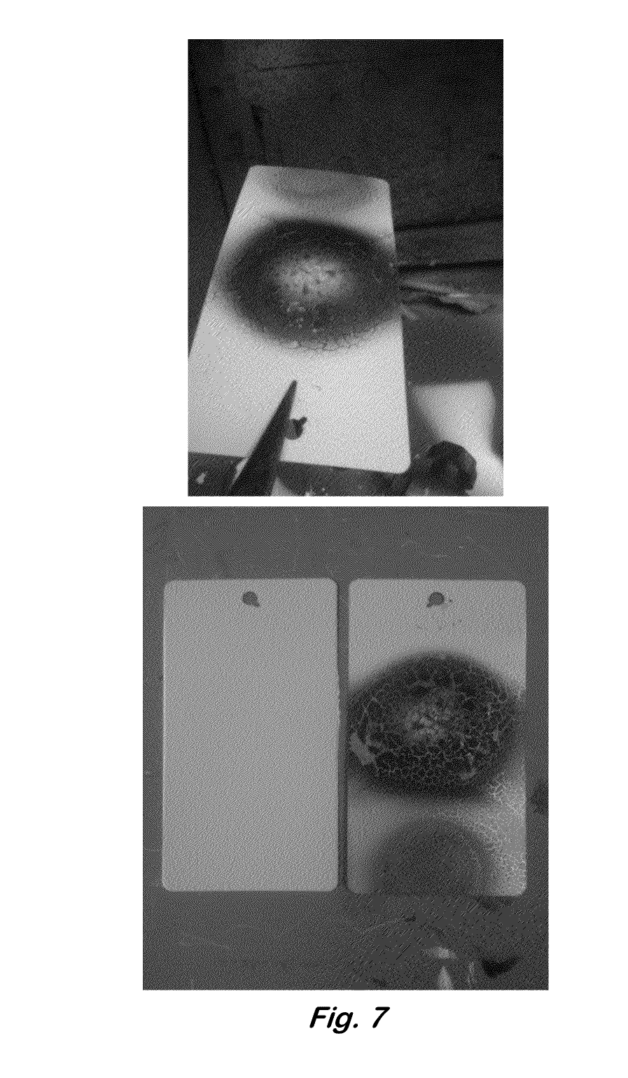

Laboratory batches have been produced using various formulations each with a desire to maximize the aesthetics of the coating (i.e., gloss) and to provide a system with the lowest smoke generation and highest resistance to ignition properties. FIGS. 4-7 illustrate some of the present formulations. The formulations vary in composition employing different percentages of adduct, coupled adducts (both organic and silicone coupled) as well as with and without polysilicate addition. In general the base formulation comprises of the organic coupled adduct as the starting formula and then varying levels of base adduct or polysilicate or both are added. As such various formulae have been developed each with a slightly different variation. Test coupons consist of 2.5″×6.0″×0.015″ aluminum panels to which the candidate systems are applied and allowed to dry for 7 days prior to screening. Fire resistance screening tests consist of simply holding coated panels over a portable butane torch and observing the performance of the coating as it is exposed to both the front and the back in the flame. The flame temperature of the torch is roughly 920° F. and panels are held in place until no more observable changes occur during the test or roughly 20 seconds. Typically the coatings begin to discolor within 3 seconds and then progresses from a tan to near black in about 10 seconds. In some instances, there may be a slight flash of blue flame for less than 1 second and a small quantity of white smoke for a few seconds, but as the test continues, these events cease. For the remaining 10-20 seconds the coatings (depending on their exact formulation) simply discolor from brown to black or remain only slightly discolored. A few formulations simply begin to craze and immediately fall off the panel after 10-15 seconds without any discoloration or product combustion.

### Example 2

### Formulations

Based on the results of the numerous trial formulations, it was determined that three samples formulations of product would generated and formally evaluated. The formulations consisted of the following:
1) Base resin with 5% melamine phosphate charring agent added and pigmented white with approximately 20 wt % TiO₂.
2) Base resin blended with polysilicate with no charring agent and pigmented 20 wt % with mixed metal oxide green.
3) Base resin with intercalated graphite added, pigmented white with 20 wt % TiO₂.

Each of the three systems also contained equally a 15 wt % distribution of micronized talc. The justification logic for each formulation is discussed below.

Formulation 1—

Based on multiple iterations and varying formulations, it was determined that the base resin is capable of resisting considerable heat before suffering from thermal breakdown. However when applied as a coating at normal thicknesses as is seen aboard ship (5-7 mils or greater), there is sufficient material mass to support moderate combustion so long as flame is present. Therefore it was speculated that if a charring agent was employed that combustion would not commence, and if so, only momentarily with little or no sustainment when heat source was present. In all cases, coatings made from the base resin are self-extinguishing.

Formulation 2—

Knowing that polysilicate is >50% oxidized silica and when fully hydrolyzed is >99% silica, it was speculated that the addition of polysilicate to the base resin during formulation would enhance the system's resistance to ignition and burning and perhaps eliminate the need for a charring agent (reduce potential toxicity)

Formulation 3—

It was speculated that the use of an intercalated nanoclay would serve as combined intumescing agent (expanding the char layer to protect underlying material from combustion) as well as perhaps a means of scavenging some of the smoke generated at the surface of the coating when exposed to heat.

### Example 3

### Sample Preparation and Application

All systems were prepared in the laboratory using a small high speed dispersion mill. No wetting agents dispersants, flow control agents, or other additives were added. Preparation was performed by grinding the complete pigment and filler mix into 20% of the total volume of resin required to make the desired coating. When the samples exhibited a suitable grind consistency, the remaining resin was added and the dispersion continued at low speed until the system was homogeneous at which point 3% catalyst was added and stirring continued until catalyst was fully dispersed. When formulation was complete, samples were allowed to “rest” 60 minutes prior to application. During the grinding process, the mix can become considerably hot and as such if applied directly after preparation, there are extensive Bernard cell and crater formations in the applied film. It was determined that for optimal appearance and uniform through film consistency, simply letting the prepared samples reside un-disturbed for 30-60 minutes and allowed to cool resulted in much better application properties and final film appearance. Application was performed using a small touch up aerosol sprayer. The current formulations investigated thus far have viscosities ranging from 20-70 Krebs units (KU) and can be easily applied using a normal airless or standard cup gun. However in order to facilitate initial screening, the systems generated in the laboratory could not be sprayed directly using the tough up spray system. Therefore all samples were diluted 30% with butyl propionate in order to facilitate small scale spray applications. The systems were applied at 5-7 mils wet to achieve nominal 3-4 mils dry and allowed to dry for 14 days at 70° F. prior to analysis.

### Example 4

### Fire Testing

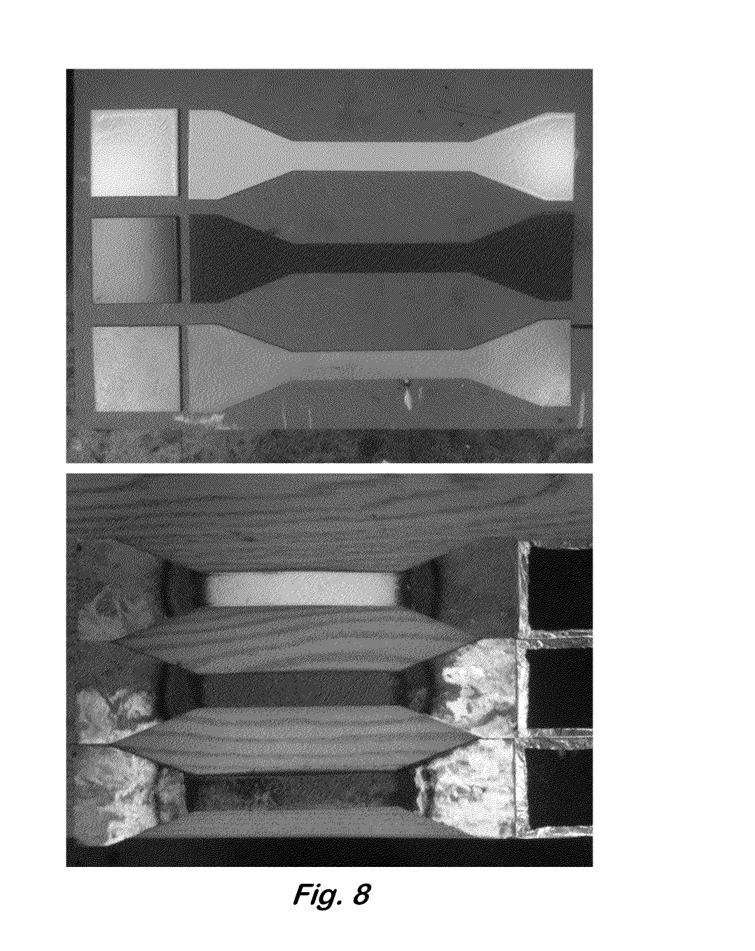

FIG. 8 shows the before and after results of the formal fire tests. The testing consisted of ASTM E662 smoke density and toxicity for 20 minutes in the burning mode and resistance to ignition in accordance with MIL-PRF-24596 sec 3.7.3. The resistance to ignition tests consists of heating the sample to 1000° F. in the span of 60 seconds. The current requirements for shipboard interior non flaming coatings are shown in Table 1.

TABLE 1
Smoke density and toxicity requirements for
shipboard non-flaming interior coatings

| smoke density (Dm) | 20 | |
|---|---|---|
| carbon monoxide (CO) | 1500 | ppm |
| carbon dioxide (CO₂) | 5% | |
| hydrogen chloride (HCl) | 100 | ppm |
| hydrogen cyanide (HCN) | 50 | ppm |

Formulation 1—

The incorporation of a charring agent did indeed arrest combustion propensity. The product did not burn. Furthermore the smoke and toxic constituents were consistent with the Navy's current system. As can be seen in FIG. 8, the sample retained its white color and has a rough vitrified ceramic-like texture. Although adherent, it can be removed by scratching with a fingernail.

Formulation 2—

The use of polysilicate as a co-reactant/diluents resulted in a coating which did not burn but did emit a near order of higher magnitude level of carbon monoxide (CO) as compared to the formulation using only the base resin. However the CO levels were still below that of the standard chlorinated alkyd. Is it speculated that the high CO levels could have come from the pigment but this has yet to be confirmed. The sample retained its green color (FIG. 8) and also has a rough vitrified ceramic-like texture. The polysilicate modified system remains more tightly adhered than formulation 1 and is difficult to remove.

Formulation 3—

As anticipated, the nanoclay system did reduce the level of smoke generation as originally proposed. Further efforts are planned to validate this result. Unlike the two previous samples, as can be seen in FIG. 8, the system was completely disbonded and consisted of a powdery ash following the test. Tables 2 and 3 show results from all three formulations.

TABLE 2
Smoke density and toxicity comparison (E662) of three 1K FRCs to
Navy Standard Interior Non-flaming Coating system (MIL-DTL-24607
chlorinated alkyd) and Navy Standard primer (MIL-DTL-244441)

| | avg. th. | | CO | CO₂ | HCL | HCN |
|---|---|---|---|---|---|---|
| sample | (mils) | Dm | (ppm) | (%) | (ppm) | (ppm) |
| 1K FRC white with charring agent | 3.2 | 10 | 75 | 0 | trace | 2 |
| 1K FRG green with polysilicate | 3.3 | 7 | 200 | 0 | 0 | 2 |
| 1K FRC gray with nano clay | 3.3 | 4 | 50 | 0.5 | 0 | 2 |
| MIL-DTL 24607 chlorinated alkyd | | 3 | 500 | 0.5 | 0.8 | 1.5 |
| MIL-DTL-24441 epoxy-polyamide | | 14 | 287 | 0.5 | 0 | 2 |

TABLE 3
Comparison (MIL-PRF-24596) of three 1K FRCs

| | avg. th. | flam- | spark- | | |
|---|---|---|---|---|---|
| sample | (mils) | ing | ing | smoke | notes |
| 1K FRC white | 3.2 | N | N | light (started | No flaking |
| with charring | | | | at 14 s) | when probed |
| agent | | | | | after exposure |
| 1K FRG green | 3.6 | N | N | light (started | No flaking |
| with polysili- | | | | at 13 s) | when probed |
| cate | | | | | after exposure |
| 1K FRC gray | 3.4 | N | Y | light (started | Material began |
| with nano clay | | | | at 12 s) | to generate |
| | | | | | strands of char |
| | | | | | @ 17 s |

Preliminary conclusions are that the 1K polysiloxane fire resistant coatings perform as well as the Navy's legacy non-flaming paint in overall performance. Being halogen free, there is no HCl generation. Although HCN values are slightly higher (by 0.5 ppm) than the legacy coating, it is still well below the specification limits. The smoke density values (Dm) are within limits. Furthermore, it is feasible to produce an effective halogen free non-flaming single component coating using polysiloxane chemistry. The resin materials can be easily synthesized from commercial raw materials without the use of specialized equipment. The resulting coatings possess the gloss, mechanical durability and adhesion performance comparable to a traditional single component air dry coating and possess the non-flaming and resistance to ignition of a halogenated system.

### Example 5

### Gloss Retention

An aspartic silane resin was prepared by a Michael addition of triethoxysilylpropyl amine and diethyl maleate. (The use of diethyl fumarate instead of diethyl maleate would produce the same product.) The Michael addition reaction was carried out at ambient temperature under light cooling. The aspartic silane was then reacted in a stoichiometric ratio with bis(4-isocyanatocyclohexyl)methane (DESMODUR W). The reaction product of the DESMODUR W with the aspartic silane constitutes the resin. The resin was essentially solvent free and had the right viscosity to formulate solvent free coatings.

A formulation was made by grinding 15 g of the resin with 1.2 g of a wetting agent (Byk 163), 10 g TiO₂ white pigment, and 5 g talcum. The “let down” or grinding phase was then combined with another 35 g of the resin and 0.3 g dibutyl tin di-acetate was added as a moisture curing catalyst. The coating material was brushed onto aluminum panels and allowed to moisture cure in air for two days. For a haze gray coating, 0.5 g yellow iron oxide, 0.78 g red iron oxide, and 0.68 g phthalo blue tint paste was added when grinding.

The panels were subjected to 2000 hours in a Q-SUN xenon arc test chamber. The gloss retention and color change from before and after the exposure were measured. For the white coating the gloss retention was 63% and the color change delta E 0.96. For the haze gray coating the gloss retention was 32% and the color change delta E 2.20.

Obviously, many modifications and variations are possible in light of the above teachings. It is therefore to be understood that the claimed subject matter may be practiced otherwise than as specifically described. Any reference to claim elements in the singular, e.g., using the articles “a”, “an”, “the”, or “said” is not construed as limiting the element to the singular.

What is claimed is:

1. A coating made by:
reacting via a first reaction a 3-trialkoxysilylpropyl amine with an organic compound having a carbon-carbon double bond activated by an electron withdrawing group to form a secondary amino propylalkoxysilane;
reacting via a second reaction the secondary amino propylalkoxysilane with an aliphatic polyisocyanate or a polymer thereof to form a reaction product having the formula: 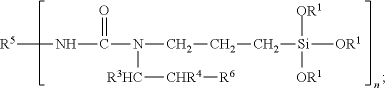
wherein each R¹ is an independently selected alkyl group;
wherein each R³ and R⁴ is an independently selected organic group;
wherein R⁵ is the residue of the polyisocyanate;
wherein R⁶ comprises the electron withdrawing group bound to a carbon atom, which is bound to the CHR⁴ group; and
wherein n is an integer greater than or equal to 2;
optionally performing a silicate condensation between the reaction product and a hydrolyzed silicate having the formula R⁷—[O—Si(OR⁷)₂]ₘ—OR⁷ to form a modified compound having the formula; 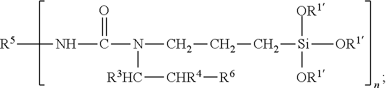
wherein each R⁷ is an independently selected alkyl group;
wherein m is a positive integer;
wherein each R^{1′} is R¹ or —(SiR⁷₂—O)ₘ—R⁷; and
wherein at least one of the R^{1′} groups is —(SiR⁷2—0)ₘ—R⁷;
applying the reaction product or the modified compound to a surface; and
moisture curing the reaction product or the modified compound to form oxygen crosslinks between silicon atoms and loss of alkyl alcohols to form the coating;
wherein the coating is inert to reactions with epoxy groups.

2. The coating of claim 1, wherein each R¹ is methyl or ethyl.

3. The coating of claim 1, wherein each R⁷ is ethyl.

4. The coating of claim 1, wherein each —CHR³—CHR⁴—R⁶ group is —CH₂—CH₂—CO—O—C₄H₉, —CH(CH₃)—CH₂—CO—O—C₄H₉, —CH(CO—O—C₂H₅)—CH₂—CO—O—C₂H₅, or —CH₂—CH₂—CN.

5. The coating of claim 1, wherein R⁵ is

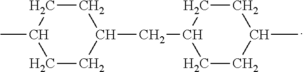

6. The coating of claim 1, wherein R⁵ is

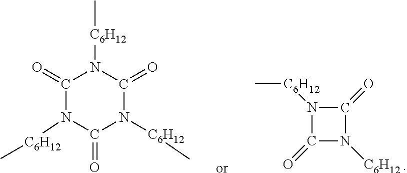

7. The coating of claim 1, wherein R⁵ is

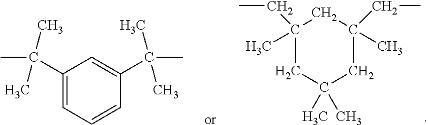

8. A method comprising:
reacting via a first reaction a 3-trialkoxysilylpropyl amine with an organic compound having a carbon-carbon double bond activated by an electron withdrawing group to form a secondary amino propylalkoxysilane;
reacting via a second reaction the secondary amino propylalkoxysilane with an aliphatic polyisocyanate or a polymer thereof to form a reaction product having the formula: 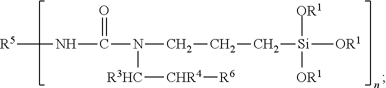
wherein each R¹ is an independently selected alkyl group;
wherein each R³ and R⁴ is an independently selected organic group;
wherein R⁵ is the residue of the polyisocyanate;
wherein R⁶ comprises the electron withdrawing group bound to a carbon atom, which is bound to the CHR⁴ group; and
wherein n is an integer greater than or equal to 2;
optionally performing a silicate condensation between the reaction product and a hydrolyzed silicate having the formula R⁷—[O—Si(OR⁷)₂]ₘ—OR⁷ to form a modified compound having the formula; 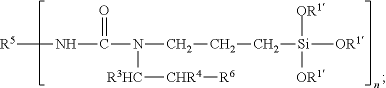
wherein each R⁷ is an independently selected alkyl group;
wherein m is a positive integer;
wherein each R^{1′} is R¹ or —(SiR⁷₂—O)ₘ—R⁷; and
wherein at least one of the R^{1′} groups is —(SiR⁷₂—O)ₘ—R⁷;
applying the reaction product or the modified compound to a surface; and
moisture curing the reaction product or the modified compound to form oxygen crosslinks between silicon atoms and loss of alkyl alcohols to form a coating;
wherein the coating is inert to reactions with epoxy groups.

9. The method of claim 8, wherein the 3-trialkoxysilylpropyl amine is 3-trimethoxysilylpropyl amine or 3-triethoxysilylpropyl amine.

10. The method of claim 8, wherein the 3-triethoxysilylpropyl amine is reacted with butyl acrylate, butyl methacrylate, diethyl maleate, diethyl fumarate, or acrylonitrile.

11. The method of claim 8, wherein each R⁷ is ethyl.

12. The method of claim 8, wherein the isocyanate is bis(4-isocyanatocyclohexyl)methane, hexamethylene diisocyanate cyclic trimer, hexamethylene diisocyanate cyclic dimer, 1,3-bis(2-isocyanatopropan-2-yl)benzene, or isophorone diisocyanate.

13. A coating made by:
reacting via a first reaction a 3-trialkoxysilylpropyl amine with an organic compound having a carbon-carbon double bond activated by an electron withdrawing group to form a secondary amino propylalkoxysilane;
reacting via a second reaction the secondary amino propylalkoxysilane with an aliphatic polyisocyanate or a polymer thereof to form a reaction product having the formula: 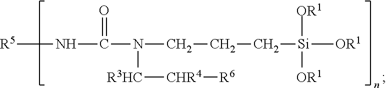
wherein each R¹ is an independently selected alkyl group;
wherein each R³ and R⁴ is an independently selected organic group;
wherein R⁵ is the residue of the polyisocyanate;
wherein R⁶ comprises the electron withdrawing group bound to a carbon atom, which is bound to the CHR⁴ group; and
wherein n is an integer greater than or equal to 2;
optionally performing a silicate condensation between the reaction product and a hydrolyzed silicate having the formula R⁷—[O—Si(OR⁷)₂]ₘ—OR⁷ to form a modified compound having the formula; 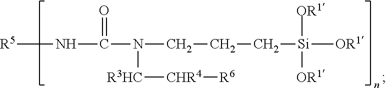
wherein each R⁷ is an independently selected alkyl group;
wherein m is a positive integer;
wherein each R^{1′} is R¹ or —(SiR⁷₂—O)ₘ—R⁷; and
wherein at least one of the R^{1′} groups is —(SiR⁷₂—O)ₘ—R⁷;
applying the reaction product or the modified compound to a surface before the moisture curing; and
moisture curing the reaction product or the modified compound to form oxygen crosslinks between silicon atoms and loss of alkyl alcohols to form a coating;
wherein the coating is at least 5 mil thick.

14. The coating of claim 13, wherein the coating is 5-7 mil thick.
